(19) United States
(12) Patent Application Publication
(10) Pub. No.: US 2006/0130591 A1
(43) Pub. Date: Jun. 22, 2006

(54) Venous needle dislodgement sensor

(75) Inventor: Lenora Ellen Perkins, Elkview, WV (US)

Correspondence Address: DANE C. BUTZER, 870 HIGH STREET, SUITE 104, WORTHINGTON, OH, 43085, US

(73) Assignee: Perkins, Corban Enterprises

(21) Appl. No.: 11/108,328

(22) Filed: Apr. 18, 2005

Related U.S. Application Data
(60) Provisional application No. 60/638,484, filed on Dec. 21, 2004.

(51) Int. Cl. G01L 1/24

(52) U.S. Cl. 73/800

(57) ABSTRACT

A dislodgement sensor for use with dialysis and other blood transfusion equipment that detects when a venous needle is dislodged from a patient. The sensor includes a photosensor attached to the venous needle or to tubing attached to the venous needle, an opaque cover placed over but not attached to the photosensor, and a signal line from the photosensor to the equipment. If the venous needle is dislodged, the photosensor is withdrawn from beneath the opaque cover, exposing the photosensor to light, which causes the photosensor to send a signal to the equipment indicating that the venous needle has been dislodged. Also, a method of using such a sensor.

### CROSS REFERENCE TO RELATED APPLICATION

This application claims priority from U.S. Provisional Application No. 60/638,484, titled “Venous Needle Dislodgement Sensor,” filed Dec. 21, 2004, in the name of inventor Lenora E. Perkins. This provisional application is hereby incorporated by reference as if fully set forth herein.

### BACKGROUND OF THE INVENTION

1. Field of the Invention

This invention relates to a sensor that detects dislodgement of a venous needle during dialysis.

2. Description of the Related Art

In dialysis, blood is drawn from an artery, passes through a dialysis machine which removes waste and toxins, and then is supplied back to a vein. Several safety devices are used to help prevent or detect problems that may arise during this process. For example, an arterial pressure gauge, venous pressure gauge and air/foam detector are typically used to ensure that blood is flowing through the apparatus properly, clots have not formed in the apparatus, and air has not been introduced into the blood flow.

The typical safety devices cannot detect one serious problem, namely dislodgement of a venous needle through which blood is supplied back to a patient. If this needle becomes dislodged, blood will not be supplied back to the patient, even though blood will continue to be drawn from the patient through an arterial needle. Because blood is flowing normally from the patient and through the dialysis equipment, the arterial pressure gauge and venous pressure gauge may not detect this problem until all the blood has been drawn from the patient. Likewise, an air/foam detector will not detect this problem. Patients often sleep through the dialysis process, so a patient might not notice the problem. Only when the patient has bled to death or is close to bleeding to death will this problem be detected by conventional safety devices or other monitoring equipment such as a heart monitor.

Some unconventional safety devices have been proposed to detect when a venous needle has become dislodged. Some of these devices measure pressure or heart beats in the blood flow upstream from the venous needle. Others detect a break in an electrical circuit that runs from a dialysis machine, though the patient (and thus the arterial and venous needles) and back to the dialysis machine. Unfortunately, none of these devices has been found to provide a sufficiently reliable and cost effective solution to the problem of detecting dislodgement of a venous needle during dialysis or blood transfusion.

### SUMMARY OF THE INVENTION

What is needed is a safety device that provides a sufficiently reliable and cost effective solution to the problem of detecting dislodgement of a venous needle during dialysis or blood transfusion.

One aspect of the invention that addresses this need is a dislodgement sensor for use with dialysis and other blood transfusion equipment that detects when a venous needle is dislodged from a patient. The sensor includes a photosensor that is exposed to light when the venous needle is dislodged, thereby signaling the equipment to turn off.

One embodiment of such a sensor includes a photosensor attached to the venous needle or to tubing attached to the venous needle, an opaque cover placed over but not attached to the photosensor, and a signal line from the photosensor to the equipment. The signal line preferably follows the tubing from the equipment, past venous fistula needle tubing, and to the patient.

If the venous needle is dislodged, the photosensor is withdrawn from beneath the opaque cover, exposing the photosensor to light. Exposure of the photosensor to light sends a signal to the equipment indicating that the venous needle has been dislodged. Then, the equipment can automatically shut off and/or an alarm can sound.

Preferably, the photosensor is attached to the venous needle or the tubing with a tubing clip such as an EZ twist lock, and the opaque cover is a gauze pad that is taped to the patient but not to the photosensor.

The invention also encompasses a method of using the dislodgement sensor.

This brief summary has been provided so that the nature of the invention may be understood quickly. A more complete understanding of the invention may be obtained by reference to the following description of the preferred embodiments thereof in connection with the attached drawings.

### BRIEF DESCRIPTION OF THE DRAWINGS

FIG. 1 shows a dislodgement sensor for use with dialysis and other blood transfusion equipment.

FIG. 2 shows a flowchart of a method for using the sensor shown in FIG. 1.

### DESCRIPTION OF THE PREFERRED EMBODIMENT

Briefly, a dislodgement sensor for use with dialysis and other blood transfusion equipment detects when a venous needle is dislodged from a patient. The sensor includes a photosensor that is exposed to light when the venous needle is dislodged, thereby signaling the equipment to turn off and/or to sound an alarm.

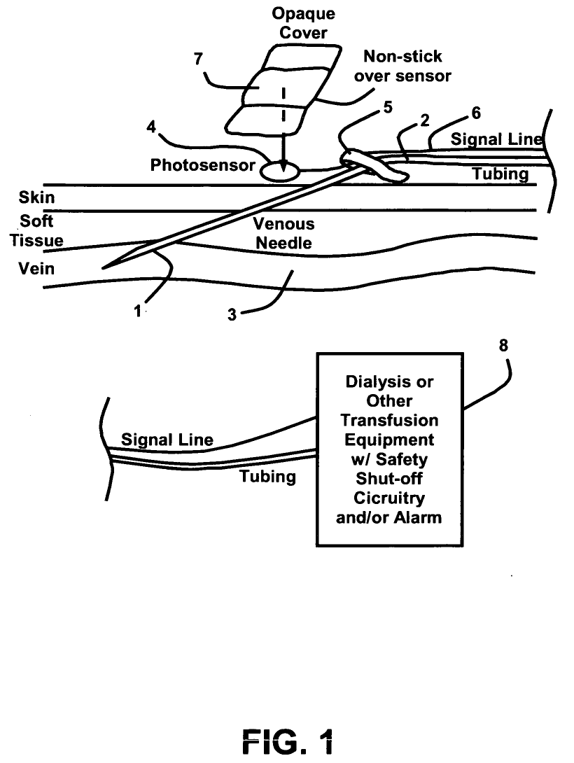

FIG. 1 show such an arrangement. Venous needle 1 for blood dialysis or transfusion through venous needle fistula tubing 2 is inserted into a patient's vein 3. Photosensor 4, for example a photodetector or miniature solar cell, is attached to the venous needle or to the tubing attached to the venous needle. In FIG. 1, the photosensor is attached via clip 5 that connects signal line 6 for the photosensor to the needle or tubing. In a preferred embodiment, the clip is an EZ twist lock.

Other types of photosensors, clips and techniques for attaching a photosensor to a venous needle or venous needle tubing can be used.

The photosensor is covered with opaque cover 7. At least a portion of the cover is non-stick. This portion is placed over the photosensor, as illustrated by the arrow in FIG. 1. A gauze pad that is taped to the patient but not to the photosensor, a regular non-stick bandage (e.g., BandAid® or Curad® brand bandage) or the like can be used as the cover. In addition, a Velcro® strap or other non-adhesive cover can be used as long as the cover is sufficiently fixed in place so that the photosensor will be uncovered if the venous needle is dislodged.

Additional elements might be present, for example a butterfly tab (not shown) for taping the venous needle fistula tubing to the patient's skin.

Signal line 6 is connected to the dialysis or other transfusion equipment 8. This equipment preferably includes safety shut-off circuitry that can shut off the equipment and/or an alarm that can sound based on a signal from the signal line. Such circuitry and alarms are well known in the electronic arts.

In operation, dislodgement of the venous needle in FIG. 1 results in the photosensor being pulled out from under the opaque cover, exposing the photosensor to light (either ambient or specifically supplied for this purpose). This exposure in turn results in a signal being sent from the photosensor to the dialysis or other transfusion equipment. The equipment can then automatically shut off, preventing the equipment from completely draining blood from the patient through a still connected arterial needle without the blood being supplied back to the patient. This automatic shut-off can quite literally save the patient's life. In addition, an alarm can sound to warn medical personnel to re-insert the venous needle.

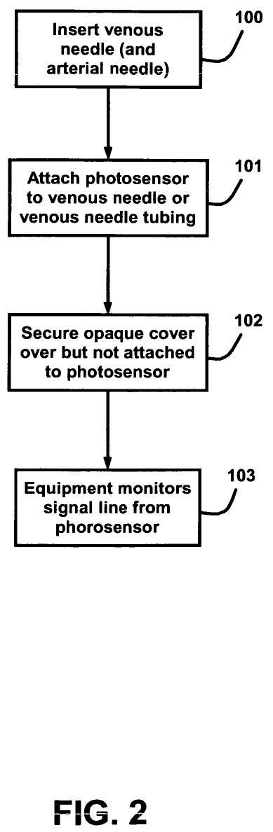

FIG. 2 shows steps for the foregoing operation. In step 100, a venous needle is inserted into a patient's vein, and an arterial needle is inserted into an artery. These needles are connected by tubing to dialysis or other blood transfusion equipment.

A photosensor is attached to the venous needle or to the tubing attached to the venous needle in step 101. A signal line runs from the photosensor to the equipment. In step 102, an opaque cover is secured over but not attached to the photosensor.

A signal line transmits a signal from the photosensor to the dialysis or other blood transfusion equipment, which monitors the signal line in step 103. If the venous needle is dislodged, the photosensor is withdrawn from beneath the opaque cover, exposing the photosensor to light. This exposure causes the photosensor to send a signal to the equipment indicating that the venous needle has been dislodged.

### Alternative Embodiments

The invention is in no way limited to the specifics of any particular embodiments and examples disclosed herein. For example, the terms “preferably,” “preferred embodiment,” “one embodiment,” “this embodiment,” and the like denote features that are preferable but not essential to include in embodiments of the invention. Many other variations are possible which remain within the content, scope and spirit of the invention, and these variations would become clear to those skilled in the art after perusal of this application.

What is claimed is:

1. A dislodgement sensor for use with dialysis and other blood transfusion equipment that detects when a venous needle is dislodged from a patient, the sensor including a photosensor that is exposed to light when the venous needle is dislodged, thereby signaling the equipment to turn off.

2. A dislodgement sensor for use with dialysis and other blood transfusion equipment that detects when a venous needle is dislodged from a patient, comprising:
a photosensor attached to the venous needle or to tubing attached to the venous needle;
an opaque cover placed over but not attached to the photosensor; and
a signal line from the photosensor to the equipment;
wherein if the venous needle is dislodged, the photosensor is withdrawn from beneath the opaque cover, exposing the photosensor to light, which causes the photosensor to send a signal to the equipment indicating that the venous needle has been dislodged.

3. The sensor as in claim 2, wherein the photosensor is attached to the venous needle or the tubing with a tubing clip.

4. The sensor as in claim 3, wherein the tubing clip is an EZ twist lock.

5. The sensor as in claim 2, wherein the opaque cover is a gauze pad that is taped to the patient but not to the photosensor.

6. The sensor as in claim 2, wherein the signal line follows the tubing from the equipment, past venous fistula needle tubing, and to the patient.

7. The sensor as in claim 2, further comprising circuitry that turns off the equipment upon receiving the signal indicating that the venous needle has been dislodged.

8. A method of detecting when a venous needle is dislodged from a patient during dialysis or other blood transfusion, comprising the steps of:
inserting arterial and venous needles connected by tubing to dialysis or other blood transfusion equipment;
attaching a photosensor to the venous needle or to the tubing attached to the venous needle, with a signal line running from the photosensor to the equipment; and
securing an opaque cover over but not attached to the photosensor;
wherein a signal line transmits a signal from the photosensor to the equipment, and wherein if the venous needle is dislodged, the photosensor is withdrawn from beneath the opaque cover, exposing the photosensor to light, which causes the photosensor to send a signal to the equipment indicating that the venous needle has been dislodged.

9. The method as in claim 8, wherein the photosensor is attached to the venous needle or the tubing with a tubing clip.

10. The method as in claim 9, wherein the tubing clip is an EZ twist lock.

11. The method as in claim 8, wherein the opaque cover is a gauze pad that is taped to the patient but not to the photosensor.

12. The method as in claim 8, wherein the signal line follows the tubing from the equipment, past venous fistula needle tubing, and to the patient.
